(19) United States
(12) Patent Application Publication
(10) Pub. No.: US 2008/0093351 A1
(43) Pub. Date: Apr. 24, 2008

(54) FLUX-CORED WIRE FOR GAS SHIELDED ARC WELDING FOR CREEP-RESISTING STEELS

(75) Inventors: Yukinobu Matsushita, Fujisawa-shi (JP); Toshiharu Maruyama, Fujisawa-shi (JP); Koichi Hosoi, Fujisawa-shi (JP); Yushi Sawada, Fujisawa-shi (JP); Ken Yamashita, Fujisawa-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/857,237

(22) Filed: Sep. 18, 2007

(30) Foreign Application Priority Data
Oct. 19, 2006 (JP) 2006-285588

(51) Int. Cl. B23K 35/368

(52) U.S. Cl. 219/145.22

(57) ABSTRACT

A flux-cored wire for gas shielded arc welding for creep-resisting steels, in which a flux is filled in a steel sheath and which is used in DC reverse polarity, comprises, based on a total weight of the wire, 1.0 to 5.0 mass % of BaF₂, 0.3 to 3.0 mass % of Al, 0.04 to 0.15 mass % of C, 0.005 to 0.040 mass % of N, 1.0 to 2.7 mass % of Cr, 0.4 to 1.3 mass % of Mo, 0.05 to 0.5 mass % of Si, 0.5 to 1.5 mass % of Mn and 85 to 95 mass % of Fe, Ni being controlled to be at 0.1 mass % or below. This flux-cored wire used as a welding material for creep-resisting steels enables welding in all positions with good toughness and embrittlement characteristics.

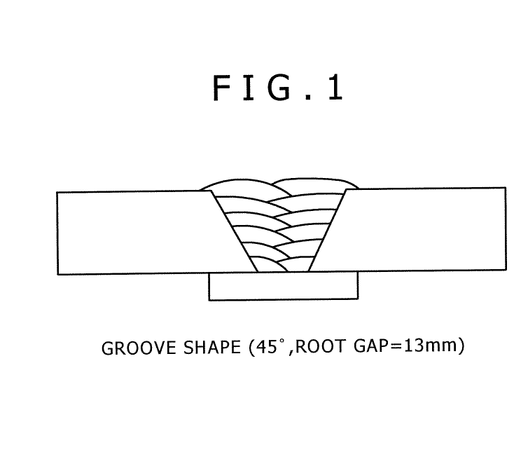

### BACKGROUND OF THE INVENTION

1. Field of the Invention

This invention relates to a welding material for creep-resisting steels employed in a variety of plants such as for nuclear power, thermal power generation, petroleum refinery and the like and more particularly, to a flux-cored wire for gas shielded arc welding for creep-resisting steels, which is able to provide a BaF₂-containing weld metal having good toughness and is excellent in welding activity in all positions.

2. Description of the Related Art

For a welding material for creep-resisting steels, there is known a titania-based flux-cored wire using TiO₂ as a main flux (U.S. Pat. No. 6,940,042). Although this titania-based flux-cored wire is good at weldability in all positions, an amount of oxygen in a weld metal is higher than those in other welding procedures and toughness has not always been at a fully satisfactory level.

On the other hand, Japanese patent No. 3511366 describes a flux-cored wire for gas shielded arc welding, which contains a Ba compound and is suited for zinc-plated steel plate welding. This Ba compound-containing flux-cored wire is a basic flux-cored wire.

However, the prior-art techniques set forth in both references mentioned above involve the following problems. More particularly, with the titania-based flux-cored wire for gas shielded arc welding, although welding activity and efficiency are excellent in all positional welding, oxides such as TiO₂ and the like are contained in large amounts in the wire as a flux and the resulting slag is acidic in nature. Hence, the amount of oxygen in a weld metal is usually as high as 700 to 900 ppm on a weight basis and has been poorer than basic wires with respect to toughness. On the other hand, although basic wires are relatively low in amount of oxygen in a weld metal and exhibit good toughness, they are far inferior in all positional welding activity to titania-based flux-cored wires.

Basic flux-cored wires are increased in amount of fluorides, for which there arise problems in that not only the amounts of weld fume and spatter increase, but also the basicity of slag increases owing to the use of CaF₂, BaF₂ or the like, thereby resulting in extreme degradation of weldability in vertical position. In this way, this prior-art technique has involved a difficulty in application to all positional welding.

The basic flux-cored wire set out in the U.S. Pat. No. 3,511,366 is one that is used for straight polarity welding (i.e. welding carried out using a wire as a minus electrode). With this straight polarity wire, all positional welding becomes possible, but with a problem in that the melting speed is low as is characteristic of the straight polarity. Accordingly, there is a demand for development of a basic flux-cored wire capable of reverse polarity welding (i.e. wire plus).

### SUMMARY OF THE INVENTION

The invention has been made in view of the problems involved in the prior art, and has for its object the provision of a flux-cored wire for gas shielded arc welding, which is able to provide a weld metal having good toughness and embrittlement characteristics in all positions when used as a welding material for creep-resisting steels and enables highly efficiency welding in wire reverse polarity.

The flux-cored wire for gas shielded arc welding for creep-resisting steels according to an aspect of the invention includes a flux-cored wire for gas shielded arc welding wherein a flux is filled in a steel sheath, the wire including, based on a total weight of the wire made up of the steel sheath and the flux, 1.0 to 5.0 mass % of BaF₂, 0.3 to 3.0 mass % of Al, 0.04 to 0.15 mass % of C, 0.005 to 0.040 mass % of N, 1.0 to 2.7 mass % of Cr, 0.4 to 1.3 mass % of Mo, 0.05 to 0.5 mass % of Si, 0.5 to 1.5 mass % of Mn and 85 to 95 mass % of Fe, Ni being defined to be at 0.1 mass % or below.

In the flux-cored wire for gas shielded arc welding, it is preferred that Mg is contained in the flux in an amount of 0.1 to 0.5 mass % relative to the total weight of the wire.

It is also preferred that the flux further includes 0.5 to 2.5 mass %, in total, of iron oxides (calculated as FeO), Mn oxides (calculated as MnO), Zr oxides (calculated as ZrO₂) and Mg oxides (calculated as MgO) in the flux.

Further, it is preferred that when the contents of Al, C and N are taken as [Al], [C] and [N], respectively, the following relationship is satisfied,

3.0≦[Al]/([C]+[N])≦15.0

According to the aspect of this invention, since BaF₂ that is a basic flux material is contained, there can be obtained a weld metal having excellent toughness, with welding activity, such as on spatter and fume, being excellent. In addition, in case of all positional welding, no problem is involved such as in sagging of a weld metal and precipitation of coarse δ-ferrite is suppressed, so that the resulting weld metal can be prevented from lowering in strength.

### BRIEF DESCRIPTION OF THE DRAWING

A sole FIGURE is a schematic sectional view illustrating a groove shape and a weld metal tested in examples and comparative examples.

### DESCRIPTION OF THE PREFERRED EMBODIMENTS

The invention is now described in more detail. In a welding material for creep-resisting steels, a titania-based, flux-cored wire including TiO₂ as a main flux component is good at weldability in all positions. However, the amount of oxygen in the weld metal is higher in welding using this wire than in other welding procedures and thus, toughness of the weld metal is not always good. Hence, in the fields such as of reactors that require high reliability in toughness and embrittlement characteristics after thermal treatment, limitation is placed on application of a titania-based flux-cored wire. For this reason, titania-based flux-cored wires have never been in wide use.

In contrast, flux-cored wires using basic flux materials or fluorides as a flux component are low in oxygen content and good in toughness. However, these basic flux materials and fluorides tend to deteriorate welding activity such as on spatter and fume and thus, a difficulty has been involved in application thereof. Additionally, weldings in all positions including vertical welding and overhead position welding are poor in activity and has been difficult. However, as a result of experimental studies made by us, it has been revealed that Ba compounds, which are a basic flux material, decompose at relatively low temperatures and the ionization energy of Ba is relatively small, for which an influence of impeding arc stability is slight. Of these, BaF₂ shows a tendency toward more excellent welding activity such as on spatter and fume than other types of fluorides.

In this connection, however, even with a BaF₂-containing flux-cored wire, there has arisen a problem on sagging of a weld metal in all positional welding.

As a result of extensive studies made by us so as to prevent a weld metal from sagging, it has been found that with the BaF₂-containing flux-cored wire, it is preferred to add Al to the weld metal in order to prevent the weld metal from sagging while keeping good arc stability.

As is known, Al is a ferrite-forming element and is liable to precipitate coarse δ ferrite in the weld metal, with the attendant problem that once the coarse δ ferrite precipitates, the strength of the weld metal lowers.

To cope with this, it is necessary to introduce a γ ferrite-forming element to prevent the precipitation of δ ferrite. For an element used for textural control to form γ ferrite, there are known Ni, Mn, C, N and the like.

However, Ni and Mn cause to promote temper embrittlement and thus, addition thereof in amounts larger than necessary is unfavorable. This is because Mn and Ni coarsen austenite crystal grains to make a small crack propagation energy from old austenite crystal grain boundaries, thereby rendering the fracture easy. Moreover, in such a basic flux-cored wire as in the present invention, Mn serves to deteriorate welding activity in overhead position welding and vertical welding. This is ascribed to the fact that among slag forming components, Mn oxides are relatively low in melting point, low in viscosity within a temperature range during welding and high in fluidity.

In the practice of the invention, precipitation of ferrite has been suppressed by addition of C and N. Especially, N is not only a γ ferrite forming element, but also serves to precipitate nitrides and M₂X, with the attendant effect that growth of a ferrite band is suppressed according to a pinning effect. In creep-resisting steels, N is an additive element effective for characteristically stabilizing the bainitic structure and martensitic structure.

Accordingly, it is preferred that the flux-cored wire of the invention includes 1.0 to 5.0 mass % of BaF₂, 0.3 to 3.0 mass % of Al, 0.04 to 0.15 mass % of C, and 0.005 to 0.040 mass % of N.

The reasons for addition and compositional ranges of individual components according to the invention are illustrated.

### BaF₂: 1.0 to 5.0 Mass %

Basis flux materials and various types of fluorides are contained in a flux and enter into a weld metal, and because of high slag basicity, an amount of oxygen in the weld metal reduces owing to the slag-metal reaction. Fluorides act to dissociate an arc atmosphere and a gasified fluorine gas raises a partial pressure of fluorine, thereby lowering a relative partial pressure of oxygen. Thus, fluorides have an effect of more reducing an amount of oxygen in the weld metal. Moreover, fluorides have the further action of reducing an amount of oxygen in a weld metal because they promote agitation of a molten metal in an arc thereby facilitating slags to be floated and separated from the molten metal.

For reducing an amount of oxygen in the weld metal, the amount of BaF₂ should be not smaller than 1.0 mass %. If the amount of BaF₂ is smaller than 1.0 mass %, little or no effect is expected. In contrast, when the amount of BaF₂ is larger than 5.0 mass %, not only the reducing effect of the amount of oxygen ascribed to BaF₂ is already saturated, but also arc stability is impeded, with no wire designing merit. Accordingly, BaF₂ ranges from 1.0 to 5.0 mass %, preferably from 1.5 to 3.5 mass %.

### Al: 0.3 to 3.0 Mass %

It is known that Al is generally low in melting point and small in ionization energy, for which arc stability is enhanced. According to our studies, especially, when BaF₂ and Al are added in combination, a significant effect of improving arc stability is expected. Al improves the viscosity of a weld metal and has a remarkable effect of preventing sagging in vertical welding position. These effects are unsatisfactory if the content of Al is smaller than 0.3 mass %. On the contrary, if the content exceeds 3.0 mass %, the resulting weld metal becomes too viscous to obtain a beautiful welding bead. If the content of Al exceeds 3.0 mass %, weldmetal properties such as toughness and mechanical properties such as a high temperature characteristic become worsened for use as 1.25Cr-0.50Mo and 2.25Cr-1Mo low alloy steels.

Accordingly, Al should be added in an amount of 0.3 to 3.0 mass %, preferably from 0.5 to 1.5 mass %. It will be noted that the addition of Al is introduced into a metal shell or a flux in the form of metallic Al or an Al compound such as an Al—Mg alloy or the like.

### C: 0.04 to 0.15 Mass %

C has an effect of improving tensile strength and toughness of a weld metal by increasing hardenability, and is an essential element in order that a weld metal for creep-resisting steels obtains given properties for use as a low alloy heat resistant steel. In the practice of the invention, aside from such an effect as mentioned above, C has an effect of serving as a γ ferrite forming element that suppresses the likelihood of δ ferrite being precipitated by addition of Al mentioned above. In order to allow the function as a γ forming element for the purpose of suppressing the formation of δ ferrite, C should be present at least in amounts of not smaller than 0.04 mass % in the wire. On the other hand, however, the addition of C in excess of 0.15 mass % causes excessive quenching and precipitation of MA in the weld metal, resulting in excess tensile strength and a considerable lowering of toughness, with some possibility that high temperature cracking is caused. Accordingly, C should range from 0.04 to 015 mass %.

It will be noted that C may be added to either or both of a metal shell and a flux. When added from a flux, a simple element or alloys such as graphite, chromium carbide, Si—C, high C—Fe—Mn, high C—Fe—Cr and the like are used.

### N: 0.005 to 0.040 Mass %

N has an effect of suppressing a ferrite band by conversion to nitride and precipitation in a weld metal. In the practice of the invention, in addition to the suppression of a ferrite band, N acts as a γ forming element for suppressing precipitation of δ ferrite caused by addition of Al.

To this end, N should be added, at least, in amounts not smaller than 0.005 mass % in the wire. On the other hand, when N is added in excess of 0.040 mass %, a solid solution N content increases, thereby degrading toughness. Excess N causes the formation of a blowhole and separation degradation of slag. For the reasons stated above, N is defined within a range of 0.005 to 0.040 mass %.

It will be noted that where N is added from a flux, metal nitrides such as N—Cr, N—Si, N—Ti and the like are used.

### Cr: 1.0 to 2.7 Mass %, Mo: 0.4 to 1.3 Mass %

In order to impart given mechanical properties and a heat resistance for use as creep-resisting steels, Cr and Mo should be, respectively, added within such ranges that Cr=1.0 to 2.7 mass % and Mo=0.4 to 1.3 mass %. The flux-cored wires, to which the invention is directed, include a flux-cored wire for low alloy steels classified as YF1CM-G in JIS Z3318 (wherein its deposit metal components are such that Cr=1.00 to 1.50 mass % and Mo=0.40 to 0.65 mass %) and flux-cored wire for low alloy steels classified as YF2CM-G (wherein its deposit metal components are such that Cr=2.00 to 2.50 mass % and Mo=0.90 to 1.20 mass %). It will be noted that AWA A5.29 has the contents of Cr and Mo in the same ranges as indicated above. In order to allow the deposit metals of Cr and Mo to be within these ranges, these components in the flux-cored wire of the invention are within such ranges of Cr=1.0 to 2.7 mass % and Mo=0.4 to 1.3 mass % while taking the yield into account.

### Fe: 85 to 95 Mass %

Fe is defined as a total of Fe in a flux and Fe in a steel sheath. In the flux, Fe is added in the form of iron powder or alloy irons such as Fe—Mn, Fe—Si, Fe—Al and the like. It has been hitherto known that these iron powder or alloy irons have an increasing effect of an amount of a weld metal by means of the iron component, thereby improving a welding efficiency. When the iron powder and alloy iron powders are mixed with other types of flux components, the fluidity of the flux can be remarkably improved as a whole. In the invention, BaF₂ used as a flux component considerably impedes the fluidity of a flux. Especially, when an iron powder or alloy iron powder is added, such an effect of increasing an amount of a weld metal as stated above is obtained, thereby ensuring excellent weldability. From the standpoint of the welding efficiency and flux fluidity, Fe should be added in amounts not smaller than 85 mass % based on the total weight of the wire. On the other hand, when Fe exceeds 95 mass %, a variety of flux components as set out above cannot be added in a satisfactory manner. Thus, the amount of Fe ranges 85 to 95 mass %.

### Si: 0.05 to 0.5 Mass %

Si is a ferrite forming element and serves to promote temper embrittlement, for which positive addition exceeding 0.5 mass % is not favorable in the field of creep-resisting steels. However, Si is an effective component for ensuring good affinity between a base metal and a weld metal, or a so-called bead affinity being made good. If the total of Si in the steel sheath and flux is smaller than 0.5 mass %, such an effect as mentioned above cannot be shown satisfactorily. Accordingly, the amount of Si ranges from 0.05 to 0.5 mass %. The amount of Si is defined as the total of Si in a flux and Si in a steel sheath, and Si in the flux is added in the form of alloys such as Fe—Si, Fe—Si—Zr and the like.

### Mn: 0.5 to 1.5 Mass %

Mn is a γ-forming element and is particularly a component effective for ensuring toughness of a weld metal containing such a large amount of Al as in the invention. However, if the total amount of Mn in the total weight of the wire is smaller than 0.5 mass %, such an effect cannot be shown satisfactorily. On the other hand, when the content of Mn exceeds 1.5 mass %, the resulting weld metal undergoes temper embrittlement in the course of thermal treatment, which makes practical applications difficult. Accordingly, the content of Mn should be within a range of 0.5 to 1.5 mass %. The content of Mn is defined as a total of Mn in the flux and Mn in the steel sheath and may be added from the flux not only in the form of metallic Mn, but also in the form of alloys such as Fe—Mn, Fe—Si—Mn and the like.

### Ni: 0.1 Mass % or Below

Ni is a γ forming element and is an effective component for ensuring toughness in a weld metal containing a large amount of Al as in the invention. However, with creep-resisting steels served for high temperature operations, Ni acts to promote temper embrittlement. To avoid this, the addition of Ni is defined within 0.1 mass % or below as a total of Ni in the total weight of the wire.

### Mg: 0.1 to 0.5 Mass %

Mg is a deoxidizing agent exhibiting high affinity for oxygen and thus, is able to reduce an amount of oxygen in a weld metal and raises viscosity. The low oxygen content in the weld metal is effective for ensuring toughness. Moreover, the Mg oxide formed is high in melting point, so that weldability in all positions is improved by coverage of a weld bead therewith. Accordingly, Mg is added as required. The addition of Mg should be 0.1 mass % or over as a total of Mg in the total weight of the wire. However, if the content of Mg exceeds 0.5 mass %, the viscosity of the resulting weld metal excessively increases, so that a weld bead does not spread. Eventually, a beautiful welded portion is not obtainable and a large amount of spatters are formed, thus such a weld metal being unsuitable for use as a welding material. Accordingly, the content of Mg ranges 0.1 to 0.5 mass %. Mg may be added from a flux not only in the form of metallic Mg, but also in the form of alloys such as Al—Mg, Fe—Si—Mg and the like.

### Oxides: 0.5 to 2.5 Mass %

Oxides contained in the wire act as nucleus forming sites in a weld metal, have an effect of miniaturizing crystal grains and are effective for toughness in As SR and also for preventing temperature embrittlement. In this sense, oxides are added, if necessary. In the practice of the invention, oxides capable of addition without appreciable degradation of welding activity in view of other essential additive fluxes include iron oxides, Mn oxides, Zr oxides or Mg oxides. For showing the effect of the oxides, the total amount of oxides is 0.5 mass % or over relative to the total weight of the wire. On the other hand, the addition of oxides in total amount not smaller than 2.5 mass % results in the degradation of welding activity such as the frequency of spatters during welding and the lowering of toughness owing to an increasing amount of inclusions in a weld metal and has to be avoided. Accordingly, iron oxides (calculated as FeO), Mn oxides (calculated as MnO), Zr oxides (calculated as ZrO₂) and Mg oxides (calculated as MgO) are added, in total amount within a range of 0.5 to 2.5 mass % of a flux.

### [Al]/([C]+[N]): 3.0 to 15.0

In order to suppress precipitation of a ferrite band and ferrite in an Al-containing weld metal, addition of a γ-ferrite forming element is necessary as stated hereinabove. In the invention, C and N, both serving as a γ-ferrite forming element, are added as stated before, and the improving effect thereof becomes more significant when taking their additive balance with Al in the weld metal into account. For balancing the amounts of Al, C and N, when taking the amounts of the respective elements in terms of [ ], [Al]/([C]+[N]) is preferably within a range of 3.0 to 15.0. We have found that when a ratio of [Al] to the total of [C] and [N] is smaller than 3.0, the amounts of C and N become too high, resulting in too high strength and thus, good toughness cannot be obtained. In contrast, when the ratio exceeds 15.0, little or no effect of ferrite suppression develops. Accordingly, it is preferred that [Al]/([C]+[N]) is in the range of 3.0 to 15.0, calculated on the basis of the total weight of the wire.

It will be noted that a flux ratio in the flux-cored wire of the invention is preferably at 10 to 25%. If the flux ratio is less than 10%, alloy components, a deoxidizing agent and a slag forming agent necessary for the wire cannot be contained in the wire. If the flux ratio exceeds 25%, wire breakage frequently takes place during the wire drawing, thereby posing a problem on the manufacture of a wire. A more preferred flux ratio is within a range of 13 to 15%.

### EXAMPLES

The effects of the invention are shown by way of a comparative test of examples of the invention and comparative examples. In the following Tables 1-1, 1-2, compositions of steel sheaths of flux-cored wires used in this test are shown. The following Tables 2-1, 2-2 show compositions of flux-cored wires (per the total weight of wire). The wire diameters are all at 1.2 mm. The flux ratio is at 14%.

TABLE 1-1

| Type of | Shell | | | | | | | | | |
|---|---|---|---|---|---|---|---|---|---|---|
| Steel | Classification | C | Si | Mn | P | S | Cu | Ni | Cr | Mo |
| Soft steel | A | 0.036 | <0.01 | 0.20 | 0.012 | 0.007 | 0.013 | 0.014 | 0.020 | 0.005 |
| | B | 0.010 | <0.01 | 0.25 | 0.006 | 0.004 | 0.011 | 0.012 | 0.019 | 0.002 |
| Low alloy | C | 0.025 | 0.50 | 1.14 | 0.003 | 0.007 | 0.012 | 0.084 | 1.39 | 0.48 |
| heat | D | 0.031 | 0.48 | 1.10 | 0.007 | 0.005 | 0.013 | 0.031 | 2.44 | 1.10 |
| resistant | | | | | | | | | | |
| steel | | | | | | | | | | |

Unit: % by mass
“<” indicates “less than” (herein and whenever it appears hereinafter).
Balance: Fe

TABLE 1-2

| | Shell | | | | | | | |
|---|---|---|---|---|---|---|---|---|
| Type of Steel | Classification | Al | Ti | Nb | V | B | N | Mg |
| Soft steel | A | 0.038 | <0.002 | 0.003 | <0.002 | <0.0002 | 0.0024 | <0.002 |
| | B | 0.008 | <0.002 | 0.003 | <0.002 | <0.0002 | 0.0033 | <0.002 |
| Low alloy heat | C | 0.004 | 0.002 | 0.003 | 0.003 | <0.0002 | 0.0080 | <0.002 |
| resistant steel | D | 0.002 | <0.002 | 0.003 | 0.004 | <0.0002 | 0.0090 | <0.002 |

Unit: % by mass

TABLE 2-1

| | Sort of | Steel | Chemical components of wire (mass %) | | | | | | | | |
|---|---|---|---|---|---|---|---|---|---|---|---|
| No. | Example | sheath | BaF₂ | Al | C | N | Cr | Mo | Mg | Si | Mn |
| 1 | Comp. Ex. | A | 0.8 | 1.4 | 0.10 | 0.030 | 1.25 | 0.52 | 0.31 | 0.32 | 0.72 |
| 2 | Example | A | 1.1 | 0.4 | 0.12 | 0.020 | 1.28 | 0.48 | 0.22 | 0.22 | 0.81 |
| 3 | Example | B | 4.7 | 1.1 | 0.06 | 0.011 | 2.28 | 1.10 | 0.31 | 0.41 | 0.72 |
| 4 | Comp. Ex. | C | 5.3 | 1.5 | 0.09 | 0.030 | 1.32 | 0.51 | 0.32 | 0.12 | 0.96 |
| 5 | Comp. Ex. | A | 2.1 | 0.2 | 0.06 | 0.020 | 1.23 | 0.52 | 0.22 | 0.15 | 1.33 |
| 6 | Example | D | 2.2 | 0.3 | 0.05 | 0.030 | 2.28 | 1.08 | 0.15 | 0.08 | 0.90 |
| 7 | Example | A | 1.3 | 2.8 | 0.11 | 0.008 | 1.26 | 0.58 | 0.47 | 0.39 | 0.88 |
| 8 | Comp. Ex. | B | 2.8 | 3.2 | 0.08 | 0.009 | 1.24 | 0.55 | 0.18 | 0.09 | 0.13 |
| 9 | Comp. Ex. | C | 3.5 | 2.5 | 0.03 | 0.016 | 1.21 | 0.48 | 0.25 | 0.21 | 0.95 |
| 10 | Example | D | 4.4 | 0.5 | 0.04 | 0.022 | 2.32 | 0.98 | 0.16 | 0.22 | 0.82 |
| 11 | Example | A | 1.3 | 0.8 | 0.14 | 0.028 | 1.22 | 0.47 | 0.38 | 0.28 | 0.61 |
| 12 | Comp. Ex. | A | 2.5 | 2.2 | 0.17 | 0.039 | 1.33 | 0.53 | 0.25 | 0.09 | 0.77 |
| 13 | Comp. Ex. | B | 4.8 | 1.3 | 0.14 | 0.004 | 1.29 | 0.59 | 0.33 | 0.15 | 0.98 |
| 14 | Example | A | 2.6 | 0.4 | 0.11 | 0.006 | 1.33 | 0.55 | 0.34 | 0.19 | 1.22 |
| 15 | Example | B | 2.9 | 0.4 | 0.08 | 0.038 | 1.28 | 0.48 | 0.36 | 0.40 | 1.10 |
| 16 | Comp. Ex. | C | 3.3 | 0.7 | 0.06 | 0.043 | 1.22 | 0.53 | 0.14 | 0.39 | 1.37 |
| 17 | Example | D | 1.4 | 1.9 | 0.10 | 0.009 | 2.33 | 1.10 | 0.08 | 0.33 | 1.11 |
| 18 | Example | A | 4.4 | 2.2 | 0.91 | 0.008 | 1.27 | 0.51 | 0.12 | 0.29 | 1.03 |
| 19 | Example | B | 4.1 | 2.8 | 0.06 | 0.009 | 1.33 | 0.51 | 0.47 | 0.39 | 0.70 |
| 20 | Example | C | 2.2 | 1.3 | 0.05 | 0.016 | 1.22 | 0.48 | 0.53 | 0.15 | 0.95 |
| 21 | Comp. Ex. | A | 1.9 | 2.1 | 0.12 | 0.033 | 1.33 | 0.53 | 0.19 | 0.04 | 1.23 |
| 22 | Example | A | 2.8 | 1.5 | 0.11 | 0.022 | 1.29 | 0.49 | 0.22 | 0.06 | 1.21 |
| 23 | Example | B | 2.9 | 0.5 | 0.13 | 0.011 | 1.31 | 0.51 | 0.28 | 0.45 | 0.92 |
| 24 | Comp. Ex. | B | 1.9 | 0.4 | 0.07 | 0.008 | 1.22 | 0.48 | 0.41 | 0.53 | 0.78 |
| 25 | Comp. Ex. | B | 4.2 | 0.9 | 0.08 | 0.006 | 1.29 | 0.53 | 0.42 | 0.06 | 0.45 |
| 26 | Example | C | 2.6 | 2.1 | 0.05 | 0.016 | 1.25 | 0.51 | 0.38 | 0.07 | 1.10 |
| 27 | Example | C | 3.3 | 1.8 | 0.11 | 0.033 | 1.21 | 0.48 | 0.28 | 0.09 | 1.41 |
| 28 | Comp. Ex. | D | 3.9 | 1.3 | 0.10 | 0.022 | 2.25 | 1.01 | 0.13 | 0.39 | 1.58 |
| 29 | Example | D | 2.9 | 0.5 | 0.08 | 0.018 | 2.18 | 0.99 | 0.19 | 0.31 | 0.62 |
| 30 | Comp. Ex. | A | 3.9 | 0.4 | 0.09 | 0.011 | 1.23 | 0.47 | 0.21 | 0.29 | 0.72 |
| 31 | Comp. Ex. | B | 4.2 | 1.4 | 0.05 | 0.006 | 1.29 | 0.57 | 0.29 | 0.31 | 0.83 |
| 32 | Example | C | 3.9 | 0.5 | 0.06 | 0.007 | 1.29 | 0.47 | 0.28 | 0.25 | 0.99 |
| 33 | Example | D | 2.9 | 0.9 | 0.11 | 0.008 | 2.23 | 1.05 | 0.13 | 0.22 | 0.78 |
| 34 | Comp. Ex. | A | 3.3 | 0.5 | 0.10 | 0.017 | 1.31 | 0.51 | 0.18 | 0.29 | 1.12 |
| 35 | Example | B | 2.9 | 0.6 | 0.09 | 0.028 | 1.27 | 0.49 | 0.11 | 0.26 | 1.39 |
| 36 | Example | C | 4.9 | 0.7 | 0.08 | 0.038 | 1.27 | 0.47 | 0.39 | 0.21 | 0.92 |
| 37 | Example | D | 2.3 | 1.5 | 0.06 | 0.033 | 2.22 | 0.98 | 0.28 | 0.22 | 0.77 |
| 38 | Example | A | 3.1 | 2.1 | 0.07 | 0.038 | 1.23 | 0.53 | 0.22 | 0.28 | 0.89 |
| 39 | Example | A | 1.4 | 1.8 | 0.07 | 0.025 | 2.28 | 1.08 | 0.33 | 0.19 | 0.98 |
| 40 | Example | A | 2.2 | 2.1 | 0.09 | 0.011 | 1.23 | 0.47 | 0.39 | 0.09 | 0.95 |
| 41 | Example | A | 3.9 | 2.2 | 0.14 | 0.006 | 1.28 | 0.51 | 0.41 | 0.07 | 1.21 |
| 42 | Example | A | 3.5 | 2.2 | 0.13 | 0.006 | 1.27 | 0.47 | 0.29 | 0.15 | 1.41 |

TABLE 2-2

| | | | Chemical components of wire (mass %) | | | | | | |
|---|---|---|---|---|---|---|---|---|---|
| | Sort of | Steel | | | Iron | | | | [Al]/ |
| No. | Example | sheath | Ni | Fe | oxide | Mn oxide | Zr oxide | Mg oxide | ([C] + [N]) |
| 1 | Comp. Ex. | A | 0.01 | 92 | 1.1 | 0.2 | 0.2 | 0.1 | 5.2 |
| 2 | Example | A | 0.02 | 91 | 0.2 | 0.5 | 0.1 | 0.3 | 10.1 |
| 3 | Example | B | 0.03 | 90 | 0.1 | 0.2 | 0.4 | 0.1 | 8.2 |
| 4 | Comp. Ex. | C | 0.01 | 88 | 0.3 | 0.3 | 0.3 | 0.3 | 9.1 |
| 5 | Comp. Ex. | A | 0.01 | 93 | 0.1 | 0.3 | 0.4 | 0.1 | 11.3 |
| 6 | Example | D | 0.03 | 86 | 0.1 | 0.3 | 0.2 | 0.1 | 5.6 |
| 7 | Example | A | 0.01 | 94 | 1.2 | 0.1 | 0.1 | 0.1 | 6.7 |
| 8 | Comp. Ex. | B | 0.03 | 93 | 0.2 | 0.2 | 0.2 | 0.2 | 13.4 |
| 9 | Comp. Ex. | C | 0.02 | 87 | 1.2 | 0.3 | tr | tr | 3.9 |
| 10 | Example | D | 0.09 | 88 | 2 | 0.1 | tr | tr | 12.1 |
| 11 | Example | A | 0.01 | 91 | tr | tr | 0.3 | 0.3 | 3.9 |
| 12 | Comp. Ex. | A | 0.02 | 92 | 0.1 | 0.2 | 0.1 | 0.4 | 4.8 |
| 13 | Comp. Ex. | B | 0.03 | 94 | 0.7 | 0.3 | 0.1 | 0.1 | 7.9 |
| 14 | Example | A | 0.04 | 87 | tr | tr | 0.7 | tr | 8.3 |
| 15 | Example | B | 0.07 | 91 | 0.4 | 0.3 | 0.3 | 0.2 | 13.5 |
| 16 | Comp. Ex. | C | 0.01 | 87 | 0.3 | 0.3 | 0.3 | 0.3 | 6.9 |
| 17 | Example | D | 0.02 | 88 | 0.1 | 0.2 | 0.3 | 0.2 | 3.8 |
| 18 | Example | A | 0.01 | 91 | 0.3 | tr | tr | 0.4 | 10.3 |
| 19 | Example | B | 0.01 | 90 | 0.7 | 0.3 | 0.4 | 0.6 | 10.7 |
| 20 | Example | C | 0.01 | 91 | 1 | 1 | 0.2 | 0.1 | 3.9 |
| 21 | Comp. Ex. | A | tr | 86 | 0.7 | 0.8 | 0.4 | 0.1 | 6.9 |
| 22 | Example | A | tr | 90 | tr | tr | tr | tr | 5.3 |
| 23 | Example | B | tr | 93 | 0.7 | 0.9 | 0.1 | 0.1 | 6.9 |
| 24 | Comp. Ex. | B | tr | 94 | 0.3 | 0.3 | 0.3 | 0.3 | 9.8 |
| 25 | Comp. Ex. | B | 0.02 | 95 | 0.4 | 0.4 | 0.1 | 0.5 | 3.8 |
| 26 | Example | C | 0.03 | 95 | 0.1 | 1.1 | 0.3 | tr | 4.5 |
| 27 | Example | C | 0.08 | 93 | 1 | 1 | 0.1 | 0.3 | 9.8 |
| 28 | Comp. Ex. | D | 0.07 | 86 | 1 | 0.5 | 0.5 | 0.1 | 3.8 |
| 29 | Example | D | 0.08 | 87 | 0.2 | 0.2 | 0.2 | 0.2 | 5.6 |
| 30 | Comp. Ex. | A | 0.13 | 94 | 0.3 | 0.3 | 0.3 | 0.3 | 6.7 |
| 31 | Comp. Ex. | B | tr | 82 | 0.6 | 0.3 | 1 | tr | 7.8 |
| 32 | Example | C | tr | 88 | 0.4 | 0.3 | 0.2 | 0.1 | 8.9 |
| 33 | Example | D | tr | 93 | 0.4 | 0.4 | 0.2 | 0.2 | 3.5 |
| 34 | Comp. Ex. | A | 0.04 | 97 | 0.3 | 0.3 | 0.3 | 0.3 | 4.8 |
| 35 | Example | B | 0.07 | 94 | 0.2 | 0.2 | tr | tr | 3.9 |
| 36 | Example | C | 0.02 | 94 | 0.3 | 0.2 | tr | 0.2 | 9.8 |
| 37 | Example | D | 0.03 | 93 | 1.9 | 0.1 | 0.1 | 0.1 | 9.1 |
| 38 | Example | A | 0.04 | 93 | 1.9 | 0.3 | 0.3 | 0.2 | 7.8 |
| 39 | Example | A | 0.04 | 93 | 0.3 | 0.5 | 0.5 | 0.5 | 2.8 |
| 40 | Example | A | 0.01 | 93 | 0.3 | 0.1 | tr | tr | 3.2 |
| 41 | Example | A | 0.01 | 86 | 0.4 | tr | tr | 0.6 | 13.5 |
| 42 | Example | A | 0.02 | 87 | 0.2 | tr | tr | 0.8 | 15.8 |

“tr” indicates “smaller than a lower limit of analysis”.

These wires were subjected to tests concerning “evaluation of welding activity”, “tensile test and impact test of weld metals after post weld heat treatment (PWHT) (under conditions of heating 690° C.×1 hour and furnace cooling)”, “embrittlement characteristic of deposit metals” and “confirmation of the presence or absence of occurrence of δ ferrite and a ferrite band”. It will be noted that in the “confirmation of the presence or absence of occurrence of δ ferrite and a ferrite band”, PWHT was effected under conditions of 690° C.×28 hours.

The sorts of test plate steels used were those of ASTM A387 GR. 11 and ASTM A387 GR. 22. The sole FIGURE shows a groove shape of these test plates. The following Table 3 show welding conditions used upon downward welding of a test plate and the following Table 4 shows welding conditions used upon vertical fillet welding. The welding activity was sensory evaluated with respect to arc stability upon welding, an amount of spatters and a bead shape. It will be noted that a shield gas composition of the examples and comparative examples was made up of 100% CO₂ for wire Nos. 40 to 42 and 80% Ar-80% CO₂ for the others. It will also be noted that for a shield gas, there may be, aside from those indicated above, ones wherein Ar gas and CO₂ gas are changed in mixing ratio, and ones wherein He gas is used in place of Ar gas as an inert gas.

TABLE 3
Welding conditions

| | | | | | Preheating/ | |
|---|---|---|---|---|---|---|
| | | | | | temperature | |
| Welding current | | Welding speed | Welding | Shield gas (flow | between | |
| A (DCEP) | Arc voltage V | cm/minute | position | rate L/minute) | passes ° C. | Remarks |
| 270 | 27~32 | 25~30 | Downward | 25 | 176 ± 15 | 2.25Cr—1Mo steel |
| | | | | | | 1.25Cr—0.5Mo steel |

TABLE 4
Welding conditions (evaluation of vertical welding activity)

| | | | | | Preheating/ | |
|---|---|---|---|---|---|---|
| | | | | | temperature | |
| Welding current | | Welding speed | Welding | Shield gas (flow | between | |
| A (DCEP) | Arc voltage V | cm/minute | position | rate L/minute) | passes ° C. | Remarks |
| 180 | 27~26 | 20~30 | Vertical | 25 | 176 ± 15 | 2.25Cr—1Mo steel |
| | | | | | | 1.25Cr—0.5Mo steel |

After weld metals being made, they were subjected to different conditions of PWHT for carrying out a tensile test and an impact test (wherein n=3) of the weld metals. With respect to the tensile test and impact test of the weld metal, the case where performances defined in the following Table were obtained was assessed as acceptable.

TABLE 5
Acceptance ranges of tensile performance and impact performance

| | | | | Acceptance range of |
|---|---|---|---|---|
| | Acceptance range of tensile performance | | | impact performance |
| Type of steel | 0.2% proof stress | Tensile strength | elongation | 2mVE-18° C. |
| 1. 25Cr—0.5Mo steel | 470 MPa in minimum | 560-690 MPa | 19% in minimum | Not smaller than 55 J |
| | value | | value | on average |
| 2. 25Cr—1Mo steel | 540 MPa in minimum | 620-760 MPa | 17% in minimum | |
| | value | | value | |

PWHT conditions: 690° C. × 1 hour, furnace cooling

The confirmation of the presence or absence of occurrence of δ ferrite and a ferrite band was made in the followed way. Six test pieces of a weld metal for observation of a sectional microstructure were sampled from a weld metal portion of a test plate after PWHT at even intervals along a weld seam, and polished and etched, followed by observation through an optical microscope to confirm the presence or absence. The evaluation was as follows: a test piece in which neither δ ferrite nor ferrite and was observed in the six sections was as acceptable, and a test piece wherein either δ ferrite or a ferrite band was observed even in one section was as unacceptable.

The following Tables 6-1, 6-2 show the results of the evaluation of the respective wire performances obtained in the above tests.

TABLE 6-1

| | Results of evaluation of activity performances | | | | | |
|---|---|---|---|---|---|---|
| | Welding activity | | | | | Amount of oxygen |
| | | Amount of spatters | | | Flux | in weld metal |
| Wire No. | Arc stability | generated | Bead shape | Separation/BH | fluidity | (ppm) |
| 1 | ◯ | ◯ | ◯ | ◯ | ◯ | 700 |
| 2 | ◯ | ◯ | ◯ | ◯ | ◯ | 250 |
| 3 | ◯ | ◯ | ◯ | ◯ | ◯ | 180 |
| 4 | X | X | X | ◯ | ◯ | 170 |
| 5 | X | X | X | ◯ | ◯ | 220 |
| 6 | ◯ | ◯ | ◯ | ◯ | ◯ | 240 |
| 7 | ◯ | ◯ | ◯ | ◯ | ◯ | 250 |
| 8 | ◯ | ◯ | X | ◯ | ◯ | 300 |
| 9 | ◯ | ◯ | ◯ | ◯ | ◯ | 280 |
| 10 | ◯ | ◯ | ◯ | ◯ | ◯ | 220 |
| 11 | ◯ | ◯ | ◯ | ◯ | ◯ | 180 |
| 12 | ◯ | ◯ | ◯ | ◯ | ◯ | 250 |
| 13 | ◯ | ◯ | ◯ | ◯ | ◯ | 210 |
| 14 | ◯ | ◯ | ◯ | ◯ | ◯ | 220 |
| 15 | ◯ | ◯ | ◯ | ◯ | ◯ | 230 |
| 16 | ◯ | ◯ | ◯ | X | ◯ | 300 |
| 17 | ◯ | ◯ | ◯ | ◯ | ◯ | 680 |
| 18 | ◯ | ◯ | ◯ | ◯ | ◯ | 280 |
| 19 | ◯ | ◯ | ◯ | ◯ | ◯ | 200 |
| 20 | X | X | X | ◯ | ◯ | 190 |
| 21 | ◯ | ◯ | X | ◯ | ◯ | 220 |
| 22 | ◯ | ◯ | ◯ | ◯ | ◯ | 240 |
| 23 | ◯ | ◯ | ◯ | ◯ | ◯ | 250 |
| 24 | ◯ | ◯ | ◯ | ◯ | ◯ | 260 |
| 25 | ◯ | ◯ | ◯ | ◯ | ◯ | 180 |
| 26 | ◯ | ◯ | ◯ | ◯ | ◯ | 180 |
| 27 | ◯ | ◯ | ◯ | ◯ | ◯ | 220 |
| 28 | ◯ | ◯ | ◯ | ◯ | ◯ | 250 |
| 29 | ◯ | ◯ | ◯ | ◯ | ◯ | 260 |
| 30 | ◯ | ◯ | ◯ | ◯ | ◯ | 230 |
| 31 | ◯ | ◯ | ◯ | ◯ | X | 240 |
| 32 | ◯ | ◯ | ◯ | ◯ | ◯ | 250 |
| 33 | ◯ | ◯ | ◯ | ◯ | ◯ | 260 |
| 34 | X | X | X | X | X | 1000 |
| 35 | ◯ | ◯ | ◯ | ◯ | ◯ | 300 |
| 36 | ◯ | ◯ | ◯ | ◯ | ◯ | 310 |
| 37 | ◯ | ◯ | ◯ | ◯ | ◯ | 210 |
| 38 | X | X | ◯ | ◯ | ◯ | 250 |
| 39 | ◯ | ◯ | ◯ | ◯ | ◯ | 260 |
| 40 | ◯ | ◯ | ◯ | ◯ | ◯ | 180 |
| 41 | ◯ | ◯ | ◯ | ◯ | ◯ | 190 |
| 42 | ◯ | ◯ | ◯ | ◯ | ◯ | 250 |

TABLE 6-2

| | | | PWHT | | | | |
|---|---|---|---|---|---|---|---|
| | | | (690° C. × 28 hours) | | PWHT (Step Cooling) | | |
| | PWHT | | Precipitation | | | Precipitation | |
| | (690° C. × 1 hour) | | of ferrite | | | of ferrite | |
| Wire | Tensile | Impact | | δ | Impact | | δ |
| No. | performance | performance | Ferrite band | ferrite | performance | Ferrite band | ferrite |
| 1 | ◯ | X | ◯ | ◯ | X | ◯ | ◯ |
| 2 | ◯ | ◯ | ◯ | ◯ | ◯ | ◯ | ◯ |
| 3 | ◯ | ◯ | ◯ | ◯ | ◯ | ◯ | ◯ |
| 4 | ◯ | ◯ | ◯ | ◯ | ◯ | ◯ | ◯ |
| 5 | ◯ | ◯ | ◯ | ◯ | ◯ | ◯ | ◯ |
| 6 | ◯ | ◯ | ◯ | ◯ | ◯ | ◯ | ◯ |
| 7 | ◯ | ◯ | ◯ | ◯ | ◯ | ◯ | ◯ |
| 8 | ◯ | X | X | X | ◯ | X | X |
| 9 | ◯ | ◯ | X | X | ◯ | X | X |
| 10 | ◯ | ◯ | ◯ | ◯ | ◯ | ◯ | ◯ |
| 11 | ◯ | ◯ | ◯ | ◯ | ◯ | ◯ | ◯ |
| 12 | X | X | ◯ | ◯ | X | ◯ | ◯ |
| 13 | ◯ | ◯ | X | X | ◯ | X | X |
| 14 | ◯ | ◯ | ◯ | ◯ | ◯ | ◯ | ◯ |
| 15 | ◯ | ◯ | ◯ | ◯ | ◯ | ◯ | ◯ |
| 16 | ◯ | X | ◯ | ◯ | X | ◯ | ◯ |
| 17 | ◯ | ◯ | ◯ | ◯ | ◯ | ◯ | ◯ |
| 18 | ◯ | ◯ | ◯ | ◯ | ◯ | ◯ | ◯ |
| 19 | ◯ | ◯ | ◯ | ◯ | ◯ | ◯ | ◯ |
| 20 | ◯ | ◯ | ◯ | ◯ | ◯ | ◯ | ◯ |
| 21 | ◯ | ◯ | ◯ | ◯ | ◯ | ◯ | ◯ |
| 22 | ◯ | ◯ | ◯ | ◯ | ◯ | ◯ | ◯ |
| 23 | ◯ | ◯ | ◯ | ◯ | ◯ | ◯ | ◯ |
| 24 | ◯ | ◯ | ◯ | ◯ | X | ◯ | ◯ |
| 25 | ◯ | X | ◯ | ◯ | ◯ | ◯ | ◯ |
| 26 | ◯ | ◯ | ◯ | ◯ | ◯ | ◯ | ◯ |
| 27 | ◯ | ◯ | ◯ | ◯ | ◯ | ◯ | ◯ |
| 28 | ◯ | ◯ | ◯ | ◯ | X | ◯ | ◯ |
| 29 | ◯ | ◯ | ◯ | ◯ | ◯ | ◯ | ◯ |
| 30 | ◯ | ◯ | ◯ | ◯ | Δ | ◯ | ◯ |
| 31 | ◯ | ◯ | ◯ | ◯ | ◯ | ◯ | ◯ |
| 32 | ◯ | ◯ | ◯ | ◯ | ◯ | ◯ | ◯ |
| 33 | ◯ | ◯ | ◯ | ◯ | ◯ | ◯ | ◯ |
| 34 | X | X | X | X | X | X | X |
| 35 | ◯ | Δ | ◯ | ◯ | Δ | ◯ | ◯ |
| 36 | ◯ | ◯ | ◯ | ◯ | ◯ | ◯ | ◯ |
| 37 | ◯ | ◯ | ◯ | ◯ | ◯ | ◯ | ◯ |
| 38 | ◯ | Δ | ◯ | ◯ | Δ | ◯ | ◯ |
| 39 | Δ | Δ | ◯ | ◯ | Δ | ◯ | ◯ |
| 40 | ◯ | ◯ | ◯ | ◯ | ◯ | ◯ | ◯ |
| 41 | ◯ | ◯ | ◯ | ◯ | ◯ | ◯ | ◯ |
| 42 | Δ | Δ | ◯ | ◯ | Δ | ◯ | ◯ |

In Tables 6-1 and 6-2, the arc stability, amount of spatters generated, bead shape, slag separation and resistance to blowhole were evaluated such that ◯ was good and X was bad. With respect to the ferrite band and the precipitation of δ ferrite, the case of no occurrence was evaluated as ◯ and the case of occurrence evaluated as X. With respect to the tensile performance, when the tensile strength is within a range indicated in Table 5, the performance is evaluated as ◯, and the performance is evaluated as X when the tensile strength is outside the range. It will be noted that those values that are within the range of the tensile strength indicated in Table 5 and are close to an upper or lower limit (within 10 MPa) are evaluated as Δ. As to the impact performance, the case where an average value of test pieces of n=3 is 55J or over and no test piece has a value smaller than 39J is evaluated as ◯, and the case where an average value of test pieces of n=3 is smaller than 55J is evaluated as X.

As will be apparent from Tables 2-1, 2-2, 6-1 and 6-2, the wires of the examples within the scope of the invention are excellent in all of the arc stability, amount of spatters generated, bead shape, slag separation and resistance to blowhole. In addition, the wires of the examples involve no precipitation of a ferrite band and δ ferrite and are excellent in impact and tensile performances.

In contrast, the wires of the comparative examples which were outside the scope of the invention were found to be poor at least in any of the characteristic performances.

The invention is effective as a welding material for creep-resisting steels employed in various types of plants such as for nuclear power, thermal power generation, petroleum refinery and the like.

What is claimed is:

1. A flux-cored wire for gas shielded arc welding for creep-resisting steels wherein a flux is filled in a steel sheath, said wire comprising, based on a total weight of the wire made up of said steel sheath and said flux, 1.0 to 5.0 mass % of BaF₂, 0.3 to 3.0 mass % of Al, 0.04 to 0.15 mass % of C, 0.005 to 0.040 mass % of N, 1.0 to 2.7 mass % of Cr, 0.4 to 1.3 mass % of Mo, 0.05 to 0.5 mass % of Si, 0.5 to 1.5 mass % of Mn and 85 to 95 mass % of Fe, Ni being controlled to be at 0.1 mass % or below.

2. The flux-cored wire according to claim 1, wherein said flux contains in an amount of 0.1 to 0.5 mass % of Mg based on the total weight of said wire.

3. The flux-cored wire according to claim 1, wherein said flux comprises 0.5 to 2.5 mass %, in total, of iron oxides calculated as FeO, Mn oxides calculated as MnO, Zr oxides calculated as ZrO₂ and Mg oxides calculated as MgO.

4. The flux-cored wire according to claim 1, wherein when the contents of Al, C and N are taken as [Al], [C] and [N], respectively, the following relationship is satisfied,
3.0≦[Al]/([C]+[N])≦15.0
